(19) United States
(12) Patent Application Publication
(10) Pub. No.: US 2006/0145807 A1
(43) Pub. Date: Jul. 6, 2006

(54) Device for protection against surge voltages

(76) Inventor: Boris Gautier, Lourdes (FR)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/538,308

(22) PCT Filed: Dec. 10, 2003
(86) PCT No.: PCT/FR03/03659

§ 371 Date: Mar. 9, 2006

(30) Foreign Application Priority Data
Dec. 10, 2002 (FR) 02/15891

(51) Int. Cl. H01H 71/16

(52) U.S. Cl. 337/36; 337/75

(57) ABSTRACT

A device for providing electrical protection against voltage surges. The device comprises a protector unit connected to the electrical equipment via a connection circuit including an electric current interrupter means movable between a return position corresponding to the circuit being open-circuit, and a position for closing the circuit. The interrupter means is maintained in the closed position by a blocker means. Further, the connection circuit is opened when the temperature of the unit reaches a predetermined value, via an opener means that that contains means sensitive to the heat given off by the unit. The heat-sensitive means is functionally connected to an actuator means so that when the predetermined temperature is reached, the actuator means produces a force for deactivating the blocker means.

### TECHNICAL FIELD

The present invention relates to the general technical field of devices for providing protection against electrical power disturbances to electrical equipment or installations, such as electrical appliances, and distribution circuits or networks.

The present invention relates more particularly to a device for providing electrical equipment with protection against voltage disturbances, such as surges, in particular those due to lightning.

The present invention relates to a protector device for protecting electrical equipment against voltage surges, the device comprising a protector unit connected to the electrical equipment via a connection circuit, said circuit comprising a first connector connected to the electrical equipment, a second connector connected to the protector unit, and electric current interrupter means movable between a return position corresponding to the circuit being open-circuit, and a position corresponding to the circuit being closed, said interrupter means comprising a rod extending between a first end provided with catch means and a second end, said rod being mounted to slide axially and resiliently between a first abutment position which is also a return position corresponding to the circuit being open-circuit, and a second abutment position corresponding to the circuit being closed, said catch means co-operating with blocker means to hold the rod in its second abutment position, said device further comprising a bimetallic strip.

### PRIOR ART

Devices for protecting electrical equipment against surges are known and are in widespread use.

Such devices, which are sometimes referred to as “lightning arrestors” serve to divert current due to lightning to ground, and to limit induced surge voltages to levels that are compatible with the voltages that can be withstood by the equipment connected downstream from the protector devices.

To do this, protector devices are generally connected between ground and the or each phase powering the equipment that is to be protected.

In normal operation, these devices present an impedance that is very high so as to avoid causing a short-circuit between ground and the phase powering the equipment that is to be protected.

In the event of a surge, for example due to lightning current, the impedance of the device drops to a value that is very low, thus enabling the current due to lightning to be diverted to ground.

Once the surge episode has terminated, the device automatically returns to its initial high impedance.

Known protector devices generally implement varistors, i.e. electrical impedances or resistors presenting a resistance or an impedance that varies strongly as a function of the applied voltage.

In use as a lightning arrestor, it is preferred to use metal oxide varistors (MOVs); these varistors present an impedance that is very high so long as the voltage across their terminals does not reach a threshold value; above the threshold, the impedance drops strongly.

Thus, in normal operation, i.e. with normal voltage levels, the impedance of the varistor is high enough for the current that passes through it to ground, referred to as the “leakage” current, to be negligible (for example a current of less than 1 milliamp (mA)).

Nevertheless, since varistors under voltage are subject to aging, where aging can be accelerated by lightning strikes, said impedance diminishes gradually, and as a result leakage current increases. This increase in leakage current has a consequence of the varistor being heated significantly by the Joule effect, with such heating itself contributing to reducing impedance and thus to increasing leakage current. This phenomenon, known as thermal runaway, leads to a considerable increase in the surface temperature of the varistor, which can for example become greater than 150° C. The heat given off by a varistor at the end of its lifetime is transmitted to the surrounding equipment, leading to severe risks of fire and/or short-circuiting.

That is why international standards governing the design of protector devices of the lightning arrestor type require the varistors included in such devices to be equipped with a thermal disconnection system for disconnecting the protector device from the equipment that is to be protected in the event of the temperature of the varistor exceeding a predetermined critical temperature. Such disconnection is generally accompanied by a visible signal informing the user that the protector device needs to be replaced.

In presently known protector devices, such as those described in patent EP-0 987 803, for example, thermal disconnection is obtained by solder melting, thereby releasing a spring, which, on relaxing, opens the electrical circuit in which the impedance of the protector device is inserted.

Although that prior art device generally gives satisfaction, it nevertheless presents a certain number of drawbacks.

Thus, the internal components of prior art protector devices are generally assembled together with solder. Nevertheless, when the varistor reaches its critical temperature, it is only the solder of the thermal disconnector that is to melt, which means that that solder needs to have a melting point that is lower than the melting point of the solder used for assembly purposes elsewhere within the device. That requires low-temperature solders to be used, which are not only more expensive, but are also very difficult to use and generally contain polluting materials such as lead or cadmium. In addition, soldering is in general terms a complex process and turns out to be particularly difficult to implement when using low-temperature solders. Thus, it is almost impossible in practice to obtain good quality solder joints with a very low melting temperature. As a result, the temperature limits that are made possible by the thermal disconnector are far from being optimum.

### SUMMARY OF THE INVENTION

The objects given to the invention are consequently to remedy the various drawbacks mentioned above and to propose a novel device for protecting electrical equipment against surges, and that enables thermal disconnection to be achieved accurately and quickly.

Another object of the invention is to propose a novel device for protecting electrical equipment against surges that is of a design that is particularly simple and reliable.

Another object of the invention is to propose a novel device for protecting electrical equipment against surges that is simple and inexpensive to manufacture.

Another object of the invention is to propose a novel device for protecting electrical equipment against surges having an improved level of safety.

Another object of the invention is to propose a novel device for protecting electrical equipment against surges that is easy to use and maintain.

The objects given to the invention are achieved by means of a protector device for protecting electrical equipment against voltage surges, the device comprising a protector unit connected to the electrical equipment via a connection circuit, said circuit comprising a first connector connected to the electrical equipment, a second connector connected to the protector unit, and electric current interrupter means movable between a return position corresponding to the circuit being open-circuit, and a position corresponding to the circuit being closed, said interrupter means comprising a rod extending between a first end provided with catch means and a second end, said rod being mounted to slide axially and resiliently between a first abutment position which is also a return position corresponding to the circuit being open-circuit, and a second abutment position corresponding to the circuit being closed, said catch means co-operating with blocker means to hold the rod in its second abutment position, said device further comprising a bimetallic strip and being characterized in that the second end of the rod is provided with a contact element establishing electrical contact between the first and second connectors when the rod is in its second abutment position, the bimetallic strip being firstly arranged in the device so as to be sensitive to the heat given off by the unit, and being secondly designed in such a manner that when the temperature of the unit reaches a predetermined critical value, the strip produces a deactivation force for deactivating the blocker means so as to cause the interrupter means to pass into its position in which the connection circuit is open-circuit.

### BRIEF DESCRIPTION OF THE DRAWINGS

Other features and advantages of the invention will be better understood in the light of the following description and the accompanying drawings, given purely by way of non-limiting illustration, and in which:

FIG. 1 is a diagrammatic view of a first variant embodiment of a device in accordance with the invention for protecting electrical equipment, in a configuration in which the temperature of the protector unit is below the critical value for thermal disconnection;

FIG. 2 is a diagrammatic view showing the FIG. 1 device in a configuration in which the temperature of the protector unit has reached or exceeded the critical value for thermal disconnection;

FIG. 3 is a diagrammatic view showing a second variant embodiment of a protector device in accordance with the invention in a configuration in which the temperature of the protector unit is below the critical value for thermal disconnection; and

FIG. 4 is a diagrammatic view showing the protector device of FIG. 3 in a configuration in which the temperature of the protector unit has reached or exceeded the critical value for thermal disconnection.

### BEST MANNER OF PERFORMING THE INVENTION

FIGS. 1 to 4 show first and second variant embodiments of a device 1, 10 for protecting electrical equipment against surges. The term “electrical equipment” is used herein to designate any type of apparatus, instrument, installation, network, electrical circuit, or telecommunications circuit that might be subjected to random voltage hazards in its electrical power supply, and in particular to voltage surges due to lightning.

The protector device 1, 10 in accordance with the invention comprises a protector unit 2, 20 constituted, for example, by a varistor, i.e. a component whose impedance (or resistance) varies as a function of the voltage applied to the varistor. The use of such components in an application to providing protection against surges is well known to the person skilled in the art and is therefore not explained in greater detail herein.

In the context of the invention, a protector unit 2, 20 thus preferably comprises one or more metal oxide varistors (MOV).

The protector unit 2, 20 is connected to the electrical equipment for protection (not shown) via a connection circuit 3, 30.

The connection of a lightning arrestor protector unit 2, 20 to equipment for protection is also well known to the person skilled in the art, and the various connection configurations are not explained herein.

As shown in the figures, the connection circuit comprises at least two electrodes 3A & 3B or 30A & 30B so as to make it possible to connect a protector unit 2, 20 electrically, e.g. in parallel, between a phase that is to be protected and ground or neutral, or indeed another phase.

Advantageously, the connection circuit 3, 30 comprises a first connector 3A, 30A electrically connected to the electrical equipment, and a second connector 3C, 30C electrically connected to the protector unit 2, 20. The first and second connectors 3A & 3C, 30A & 30C are made of any conductive material, as is well known to the person skilled in the art.

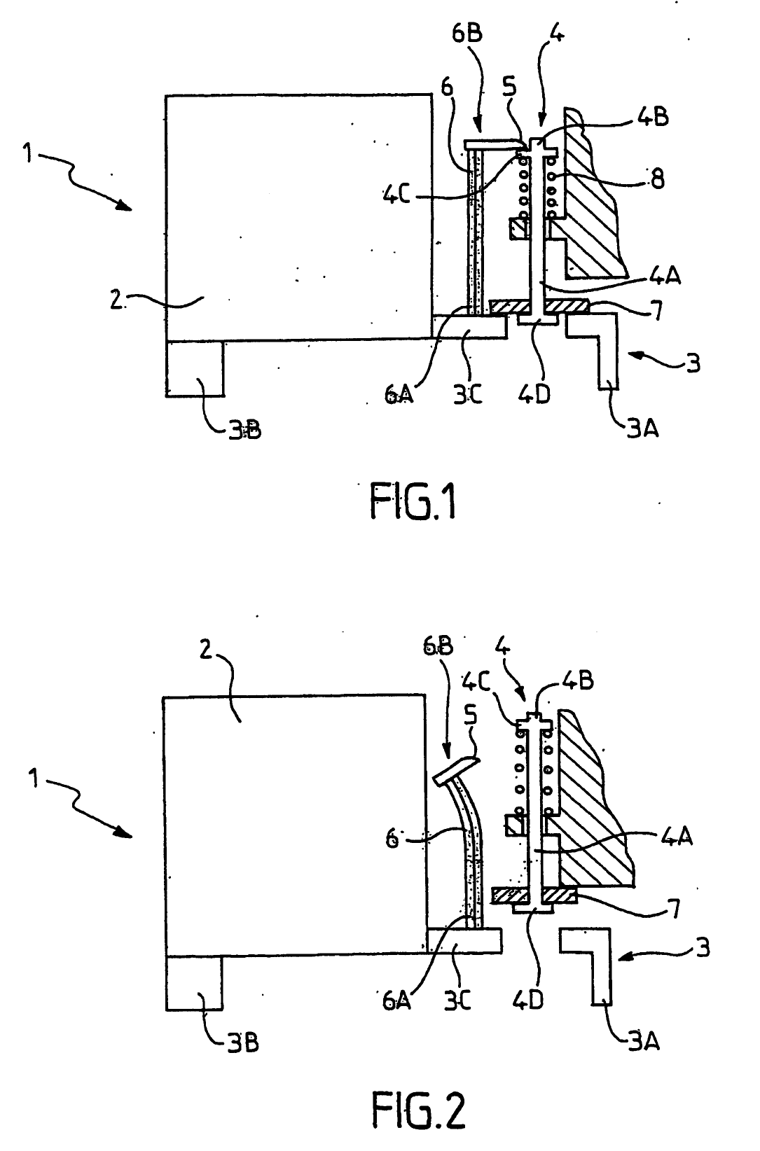

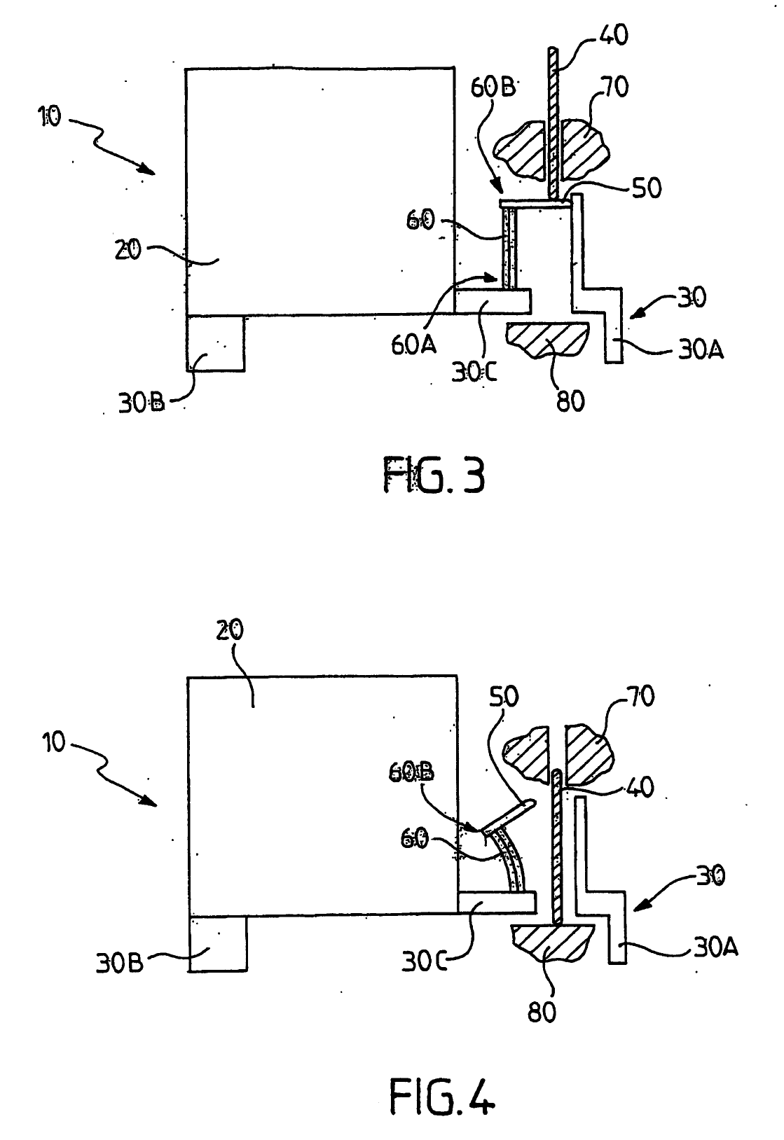

The connection circuit 3, 30 also includes electric current interrupter means 4, 40. Said electric current interrupter means 4, 40 is mounted to move relative to the remainder of the device 1, 10 between a return position (shown in FIGS. 2 and 4) corresponding to the circuit 3, 30 being open-circuit, and a position in which the circuit 3, 30 is closed (shown in FIGS. 1 and 3). In normal operation, the interrupter means 4, 40 is held in its position for closing the circuit 3, 30 by blocker means 5, 50.

The protector device 1, 10 in accordance with the invention also comprises opener means 6, 60 for opening the connection circuit 3, 30 when the temperature of the unit 2, 20 reaches a predetermined critical value, above which the heat given off by the protector unit 2, 20 runs the risk of damaging or setting fire to the surrounding elements. The opener means 6, 60 thus form thermal disconnector means for triggering the interrupter means 4, 40 to pass into the open position. In the open position, the protector unit 2, 20 no longer carries current, and therefore ceases to be heated, thereby eliminating the above-mentioned risk.

According to the invention, the opener means 6, 60 comprises means 6, 60 that is sensitive to the heat given off by the unit 2, 20, whether by radiation and/or by conduction and/or by convection.

In other words, the heat-sensitive means 6, 60 is arranged in the device to detect directly that the unit 2, 20 has reached a predetermined critical temperature.

According to an essential characteristic of the invention, the heat-sensitive means 6, 60 is functionally connected to actuator means 6, 60 so that when said predetermined critical temperature of the unit 2, 20 is reached, the actuator means 6, 60 produces a force for deactivating the blocker means 5, 50 in order to cause the interrupter means 4, 40 to pass into a position for opening the connection circuit 3, 30, as shown in FIGS. 2 and 4.

Thus, when the heat-sensitive means 6, 60 detects that the predetermined critical temperature of the unit has been reached, the actuator means 6, 60 exert positive triggering action on the interrupter means 4, 40, thereby interrupting the electric current.

In a first variant embodiment shown in FIGS. 1 and 2, the interrupter means 4 comprise a rod 4A extending axially between distinct first and second ends 4B, 4D.

The term “rod” is used herein to mean any element of the slider or moving equipment type, and it need not necessarily be elongate in shape.

The first end 4B is provided with catch means 4C, e.g. formed by a collar, while its second end 4D is provided with a contact element 7 made of an electrically conductive material. In this first variant embodiment, the catch means 4C is distinct from the contact element 7. In other words, the catch means 4C preferably does not perform the function of conducting electricity, while the contact element 7 on the contrary preferably performs solely the function of conducting electricity.

The rod 4A is mounted to slide axially and resiliently, e.g. under drive from a compression spring 8, between a first abutment position which is also a return position, corresponding to the circuit 3 being open-circuit (shown in FIG. 2), and a second abutment position (shown in FIG. 1) corresponding to the circuit 3 being closed, in which position the contact element 7 establishes electrical contact between the first and second connectors 3A and 3C. The catch means 4C co-operate with the blocker means 5, e.g. by pressing or hooking, to hold the rod 4A in its second abutment position corresponding to normal operation of the protector device. Thus, the interrupter means 4 is prestressed in the closed position (shown in FIG. 1) by the blocker means 5.

Preferably, the heat-sensitive means and the actuator means are the same means and are constituted by a bimetallic strip 6. Bimetallic strips are elements that are well known in themselves. They are made by placing side-by-side two metal strips having different expansion characteristics, in a configuration such that at a certain temperature level, in this case corresponding to the predetermined critical temperature, the bimetallic strip deforms in bending (shown in FIG. 2).

By bending, bimetallic strips thus make it possible to perform two functions: that of detecting temperature, and that of performing actuation.

In the above-described first variant embodiment, a preferably single bimetallic strip 6 serves both to act as the heat-sensing means and to act as the actuator means.

For this purpose, the bimetallic strip 6 is arranged specifically, i.e. mounted and positioned in the device specifically, so as to be sensitive to the heat given off by the unit 2, so as to detect when said unit reaches the predetermined temperature representative of the unit reaching a degree of aging that is incompatible with safety requirements. The bimetallic strip 6 is thus preferably mounted to be sensitive for the most part to the heat given off by the unit 2, to the exclusion of other thermal phenomena.

The bimetallic strip 6 is also designed, in particular from the point of view its capacity for bending, to produce a force, when it bends on the predetermined temperature being reached, that is suitable for deactivating the blocker means 5, thereby releasing the rod 4A and consequently allowing the interrupter means 4 to pass from its closed position to its position in which it opens the circuit 3.

Advantageously, one of the ends 6A of the bimetallic strip 6 is mounted stationary relative to the first and second connectors 3A, 3C. Preferably, this end of the bimetallic strip 6 is embedded in the second connector by a cold assembly method, e.g. clip-fastening, crimping, or riveting. The other end 6B of the bimetallic strip 6 is free and is provided with an abutment 5 constituting the blocker means. The abutment 5 is constituted, for example, by a plate fitted to the free end 6B by any known means. The bimetallic strip 6 is selected and arranged so as to bend when the predetermined temperature is reached, with the bending producing the deactivation force that enables the abutment 5 to be moved away from the catch means 4C, thus interrupting the co-operation between the catch means 4C and the blocker means 5.

Interrupting mechanical co-operation between the catch means 4C and the blocker means 5 thus causes the rod 4A to rise, thereby disconnecting the contact element 7 simultaneously both from the first connector 3A and from the second connector 3C.

This sudden pair of disconnections, obtained by separating the contact element 7 from both the first and the second connectors 3A, 3C, imparts excellent reliability to the device in accordance with the invention.

Thus, the activator means formed by the bimetallic strip 6 produces a force that moves away the blocker means 5, thereby triggering relaxation of the stress applied by the spring 8 to the rod 4A and to the contact element 7.

In preferred manner, the bimetallic strip 6 is arranged so that its maximum deflection in its bent position takes place at the free end 6B of the bimetallic strip 6.

Preferably, in the first variant embodiment described above, the bimetallic strip 6 does not form part of the connection circuit 3. In other words, even though the bimetallic strip 6 is intrinsically capable of conducting electricity, its function in the context of this variant embodiment is not to carry current to the protection unit 2.

This function of carrying current is performed entirely by the contact element 7 which establishes an electrical connection between the first and second connectors 3A, 3C. The bimetallic strip 6 serves solely to perform the functions of detecting temperature and of deactivating the blocker means 5.

This design feature thus protects the bimetallic strip from being subjected to parasitic temperature influences that might arise from its own resistance, since practically no electricity flows through it.

In addition, the fact that the bimetallic strip 6 does not form part of the connection circuit 3 makes it possible to avoid undesirable current loop effects which could lead to mechanical forces being generated that would be harmful for the reliability and the operation of the device.

In another variant embodiment that is not shown in the figures, the device shown in FIGS. 1 and 2 is reproduced identically, with the exception that the assembly comprising the bimetallic strip and the blocker means 6, 5 is replaced by a system comprising a thermistor (with positive or negative temperature coefficients) as the means for sensing heat, said thermistor being associated with electromechanical or electromagnetic means forming the actuator means, via appropriate processing electronics. It is also possible to envisage using a thermocouple or any other temperature sensor well known to the person skilled in the art as the heat-sensing means. An example of an embodiment in the context of this variant is as follows. A thermistor detects the predetermined critical temperature by a sudden change in resistance. This change in resistance is sensed and processed by an electronic circuit or an electrical apparatus such as a relay, which connects the thermistor functionally to the actuator means, which means is suitable for delivering sufficient magnetic force to move the abutment 5 away from the catch means 4C. The deactivation force is then electromagnetic in nature, whereas when a bimetallic strip 6 is used, this force is mechanical in nature.

Another embodiment of the protector device in accordance with the invention is described below. This embodiment is shown in FIGS. 3 and 4. The general architecture of the variant of FIGS. 3 and 4 is similar overall to that of the variant shown in FIGS. 1 and 2. The main differences lie in the way in which the interrupter means 40 is made.

The blocker means 50 comprises a conductor element 50, e.g. made of metal, electrically connected to the second connector 30C. The conductor element 50 is mounted to move between firstly a closed position (shown in FIG. 3) where it is in electrical contact with the first connector 30A so as to close the connection circuit 30, and secondly an open position (shown in FIG. 4) where it is moved away from the first connector 30A so that the circuit 30 is open and electricity no longer flows through the unit 20.

The interrupter means 40 comprises an insulating screen 40 mounted to slide freely relative to the first and second connectors 30A, 30C, e.g. in a slideway formed in a guide 70. The screen 40 is made of an electrically insulating material. It can move by sliding between a first abutment position (shown in FIG. 3) where it presses against the conductor element 50 while it is in the closed position, and a second abutment position which is also a return position (shown in FIG. 4) where it is interposed between the conductor element 50 and the first connector 30A, with the conductor element 50 then being in the open position (as shown in. FIG. 4).

Advantageously, the heat-sensitive means and the actuator means 60 are the same means, being formed by a bimetallic strip 60 having one of its ends 60A that is secured by any suitable means, e.g. by a cold assembly process such as clip-fastening, crimping, or riveting, to the second connector 30C. The bimetallic strip 60 which is made using conductive materials is also connected electrically to the second connector 30C, and this can be done merely by assembling the bimetallic strip 60 to the connector 30C.

The other end 60B of the bimetallic strip is free and is secured to the conductor element 50, which is formed by a metal plate or rod, for example.

The bimetallic strip is arranged to bend when the unit 20 reaches the predetermined critical temperature. Preferably, the bimetallic strip 60 is arranged in such a manner that its maximum deflection in the bent position is situated at the free end 6B of the bimetallic strip 6. By bending in this way, the bimetallic strip produces the deactivation force which enables the conductor element 50 to be moved away from the first connector 30A, the conductor element 50 thus subsequently releasing the insulating screen 40 which, under the effect of gravity or under resilient biasing means such as a spring (not shown), falls and slides so as to press in abutment against support means 80 forming part of the guide, thus being interposed between the conductor element 50 and the first connector 30A (as shown in FIG. 4). The presence of the insulating screen 40 thus prevents any subsequent contact between the conductor element 50 and the first connector 30A, as might occur when the bimetallic strip 60 returns to a natural (non-bent) configuration once the unit 20 has cooled down.

In addition, the presence of an insulating screen 40 offers the advantage of preventing any risk of an electric arc forming between the conductor element 50 and the connectors 30A.

In this variant, it is also possible to envisage replacing the bimetallic strip 60 with a thermistor (or any other element suitable for sensing temperature) as the heat-sensing means, in association with electromechanical or electromagnetic means as the actuator means.

The examples of interrupter means 4, 40, of heat-sensing means 6, 60, and of actuator means 6, 60 as given above are given purely by way of indication, but a single bimetallic strip is nevertheless preferred.

Thus, other variants could be devised, e.g. having interrupter means mounted to turn about an axis and including a torsion spring so as to operate like a rachet, or indeed actuator means implementing an electric motor.

It can thus be seen that a multitude of variant embodiments of the invention can be devised, and that it is perfectly possible to implement means different from those mentioned above without thereby going beyond the ambit of the invention.

It is of particular interest to observe that the protector device in accordance with the invention, as shown in FIGS. 1 to 4 can be reset. The thermal disconnection means used, whether in the form of bimetallic strips or thermistors associated with electromechanical or electromagnetic means, are of a reversible nature, thus enabling them to be returned to their initial state once the temperature has returned to below the predetermined critical temperature. This possibility is not provided by the prior art device that uses solder as the thermal disconnection means, since, very specifically, the solder joint is destroyed when the predetermined critical temperature is reached. Thus, not only does the device in accordance with the invention implement positive action, in the form of a deactivation force or achieving thermal disconnection, it also presents the characteristic of being reversible.

This reversible characteristic thus makes it possible to envisage encapsulating the protector unit 20 in a first module for being associated by connector means, e.g. using pins, to a second module comprising the interrupter means 4, 40, the heat-sensitive means 6, 60, and the actuator means 6, 60, the heat-sensing means and the actuator means preferably being formed by a single bimetallic strip. The connector means, of the type providing both contact and fastening between the modules, enable modules to be associated functionally (i.e. electrically and thermally), in a manner that is separable. Thus, when a unit 20 is damaged or no longer performs its functions, it suffices to change the module that contains the unit 20 and replace it with a new module, and then to reset the interrupter means 4, 40 in order to obtain a functional protector device again.

Susceptibility of Industrial Application

The invention finds this application in the design and manufacture of devices for providing protection against surge voltages.

1. A protector device (1) for protecting electrical equipment against voltage surges, the device comprising:
a protector unit (2) connected to the electrical equipment via a connection circuit (3);
said connection circuit comprising:
a first connector (3A) connected to the electrical equipment;
a second connector (3C) connected to the protector unit (2); and
electric current interrupter means (4) movable between a return position corresponding to the circuit (3) being open-circuit, and a position corresponding to the circuit (3) being closed;
said interrupter means (4) comprising:
a rod (4A) extending between a first end (4B) provided with catch means (4C) and a second end (4D); and
said rod (4A) being mounted to slide axially and resiliently between a first abutment position which is also a return position corresponding to the circuit (3) being open-circuit, and a second abutment position corresponding to the circuit (3) being closed;
said catch means (4C) co-operating with blocker means (5) to hold the rod (4A) in its second abutment position, position;
said device further comprising a bimetallic strip (6) wherein the second end (4D) of the rod (4A) is provided with a contact element (7) establishing electrical contact between the first and second connectors (3A, 3C) when the rod is in its second abutment position, the bimetallic strip (6) being firstly arranged in the device so as to be sensitive to the heat given off by the protector unit (2), and being secondly designed in such a manner that when the temperature of the protector unit (2) reaches a predetermined critical value, the bimetallic strip produces a deactivation force for deactivating the blocker means (5) so as to cause the interrupter means (4) to pass into its position in which the connection circuit (3) is open-circuit.

2. The device according to claim 1, wherein the device includes a single bimetallic strip (6).

3. The device according to claim 1 wherein the bimetallic strip (6) does not form part of the connection circuit (3).

4. The device according to claim 1, wherein one of ends (6A) of the bimetallic strip (6) is mounted to be stationary relative to the first and second connectors (3A, 3C), while the other end (6B) is free and is provided with an abutment (5) forming the blocker means, said bimetallic strip (6) being arranged to bend when the predetermined temperature is reached, and by bending to produce the deactivation force enabling the abutment (5) to be moved away from the catch means (4C), thereby interrupting co-operation between them.

5. The device according to claim 1, wherein the protector unit (2) comprises at least one varistor.

6. The device according to claim 1, wherein the bimetallic strip (6) is mounted in the device by a cold assembly method such as clip-fastening, crimping, or riveting.

7. The device according to claim 1, wherein the current interrupter means (4) is resettable.

8. The device according to claim 1, further comprising a first module with the protector unit (2, 20), and a second module with the interrupter means (4, 40) and the bimetallic strip (6), connector means being provided between the modules so as to enable them to be functionally associated in separable manner.
